(19) United States
(12) Patent Application Publication
(10) Pub. No.: US 2014/0247619 A1
(43) Pub. Date: Sep. 4, 2014

(54) LIGHT DIFFUSION APPARATUS AND METHODS FOR INTERIOR SPACE ILLUMINATION

(71) Applicant: CORNING INCORPORATED, Corning, NY (US)

(72) Inventors: Kevin Wallace Bennett, Hammondsport, NY (US); Richard Bergman, Horseheads, NY (US); Stephen Lvovich Logunov, Corning, NY (US); Vineet Tyagi, Elmira Heights, NY (US)

(73) Assignee: CORNING INCORPORATED, Corning, NY (US)

(21) Appl. No.: 14/191,870

(22) Filed: Feb. 27, 2014

Related U.S. Application Data
(60) Provisional application No. 61/772,128, filed on Mar. 4, 2013.

(51) Int. Cl. F21V 5/00; F21V 33/00; F25D 27/00; F21K 99/00

(52) U.S. Cl. CPC F21V 5/00; F21K 9/00; F21V 33/0044; F25D 27/00; F21W 2131/305
USPC 362/558; 362/311.01; 362/311.02; 362/92

(57) ABSTRACT

An apparatus including: an illumination source; and a climate controlled enclosure having at least one light diffusion element situated within the enclosure, the at least one light diffusion element being in photonic communication with the illumination source, and the illumination source being remote to the enclosure. The disclosure also provides a method of using the apparatus to illuminate the interior of the apparatus and optionally the contents of the apparatus.

### CROSS-REFERENCE TO RELATED APPLICATION(S)

This application claims the benefit of priority to U.S. Application No. 61/772128 filed on Mar. 4, 2013, the content of which is incorporated herein by reference in its entirety.

This application is also related to commonly owned and assigned applications that mention, for example: the use of light diffusing fiber for a variety of applications, including for example, illumination and photochemistry (see, e.g., U.S. patent application Ser. No. 13/269,071 filed Oct. 7, 2011, entitled “MEANS OF PHOTO-CURING OR PERFORMING PHOTO-CHEMISTRY”; U.S. patent application Ser. No. 13/269,055, filed Oct. 7, 2011, entitled “FLEXIBLE FIBER BASED LIGHTING FOR ILLUMINATION APPLICATIONS”; U.S. patent application Ser. No. 13/713,224 filed Dec. 13, 2012, entitled “UNIFORM WHITE COLOR LIGHT DIFFUSING FIBER”; and U.S. patent application Ser. No. 13/713,248, filed Dec. 13, 2012, entitled “UNIFORM UV EFFICIENT LIGHT DIFFUSING FIBER”.) The light diffusing fiber can use, for example, one or more light engines such as a laser diode or an LED situated, for example, at each end of a fiber, a bundle of fibers, or a rod, to illuminate the fiber. These commonly owned applications mention examples of laser light engines; and U.S. Patent Application No. 61/751,437, filed Jan. 11, 2013, entitled “LIGHT DIFFUSING FIBER BUNDLES AND METHODS FOR COUPLING,” mentions examples of LED illumination. The design of a light diffusing preform element (i.e., a rod) is described in U.S. patent application Ser. No. 13/800,184 (SP13-069), filed Mar. 13, 2013, entitled “LIGHT-DIFFUSING ELEMENTS”. The contents of the foregoing applications are relied upon and incorporated herein by reference in their entirety. However, the present application does not claim priority to these other related applications.

### BACKGROUND

The disclosure relates to an apparatus and methods for illumination of a climate controlled space.

### SUMMARY

The disclosure provides an apparatus and methods for remotely illuminating a climate controlled space, such as temperature, humidity, pressure, and like variables (e.g., an environmentally controlled space), for example, an enclosure, such as a refrigerated area of a closed refrigerated beverage cooler, or an open refrigerated supermarket display case, a high humidity area, or like enclosures.

### BRIEF DESCRIPTION OF THE DRAWINGS

In embodiments of the disclosure:

FIG. 1 shows an example deployment scheme for a light diffusing fiber (LDF) within a climate controlled enclosure, such as a standing beverage cooler.

FIGS. 2A to 2C shows exemplary delivery or distribution architectures for LDF illumination useful in the present disclosure.

FIG. 3 shows an exemplary deployment scheme for a disclosed apparatus and method using LDF equipment and methods within an industrial or large scale setting.

FIG. 4 shows, in plan view, another exemplary deployment scheme and apparatus for a light diffusing fiber within a climate or environmentally controlled enclosure.

FIGS. 5A to 5C show, in cross-section, exemplary unmodified and modified (e.g., coated or masked) LDF fibers and their accompanying illumination patterns.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed apparatus, and the disclosed method of making and using the apparatus provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### Definitions

“High coupling efficiency” between the illumination source and the light diffusing element refers to, for example, the percentage yield of photons out or photons leaving the LDF divided by the photons in or provided or transmitted from the source to the LDF.

“High communication efficiency” between the illumination source and the light diffusing element refers to, for example, the percentage yield of information out or information leaving the LDF divided by the information in or provided or transmitted from the source to the LDF.

“Include,” “includes,” or like terms refers to encompassing but not limited to, that is, inclusive and not exclusive.

“About” modifying, for example, the quantity or extent in a composition, concentration, volume, process temperature, process time, yield, flow rate, pressure, viscosity, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations.

“Optional” or “optionally” means that the subsequently described event, element, or circumstance can or cannot occur, and that the description includes instances where the event, element, or circumstance occurs and instances where it does not.

“Consisting essentially of” in embodiments can refer to, for example:
An apparatus having:
an illumination source; and
a climate controlled enclosure having at least one light diffusion element situated within the enclosure, the at least one light diffusion element being in photonic communication with the illumination source, and the illumination source being remote to the enclosure; and

A method of using the apparatus including: remotely illuminating the interior space of the climate controlled enclosure of the abovementioned apparatus, including:
transmitting light from the illumination source to at least one light diffusion element situated within the enclosure to illuminate the interior space of the enclosure, as defined herein.

Some unique features of light diffusing fiber are, for example, the physical flexibility of the light diffusing fiber. The flexibility permits the use of, for example, phosphor based coloration without significant heat buildup, and the ability to remotely place or situate the illumination source(s) from the area or space where the illuminating light is ultimately delivered. The fiber flexibility also permits placing the light where desired, such as in straight lines, around curves, or a combination thereof.

Certain commercially available refrigerators and coolers used in retail or industry are illuminated by light sources situated inside the cooled space. The light source can produce heat inside the cooled space and the heat can compete with and must be removed to maintain the cool interior temperature level. This internal illumination source heating and the increased cooling demand to counter the internal heating results in increased energy consumption compared to if illumination heating was absent (see C -J Weng; International Communications in Heat and Mass Transfer; 2009, 36(3), 245-248; R. D. Galli; U.S. Pat. No. 6,966,677 (flashlight); and Arik, C., Third International Conference on Solid State Lighting, Proceedings of the SPIE; 2004, 5187, 64-75).

Another issue encountered with the use of conventional light sources in a cool space is that conventional light source lumen efficacy decreases in cold environments and more power is needed to achieve the desired illumination level. The low temperatures and power overload conditions can also decrease the lifetime of the conventional light sources. A further shortcoming of conventional light sources inside or within a cool space is when moisture condensation on electronic circuitry or related components decreases the lifetime of the electronics by, for example, shorting and related mechanisms.

In embodiments, the disclosed apparatus and methods can be used in a high humidity environment, a humidity controlled environment, or both, when, for example, the relative humidity (RH) can exceed 50% locally and pose a condensation risk. This high relative humidity condition and condensation risk can occur, for example, where warm humid ambient air enters or penetrates a cooled space, or in a warm, humid environment that can have local cold spots or surfaces, such as in an 85/85 chamber.

The present disclosure provides an apparatus and methods for illuminating a climatically controlled enclosure, such as a cool space, where an external illumination source avoids or eliminates internal heating, that is, the source does not generate heat within the cooled space nor transfer significant heat into the cooled space. The present apparatus and methods also do not lose lumen efficacy with decreasing temperatures and can provide extended service life to the illumination source by keeping it out of the cool space. Additionally, repair or replacement of a damaged or defective remotely, that is externally, situated illumination source can be significantly facilitated by, for example, ease of access, modularity, operator comfort, security, and like considerations.

In embodiments, the disclosed apparatus can have various external placements or locations for the photon source or light engine when used in combination with, for example, a light diffusing fiber to afford lighting designs that can provide energy and space efficiency improvements for the climate, that is for example, the temperature or environmentally controlled interior space, such as a closed refrigerator, an open refrigerated display case, a refrigerated storage area, a refrigerated food processing area such as meat packing or poultry processing, a beverage or snack cooler, a vending machine, a semiconductor fabrication facility, a materials extraction facility such as a mine shaft, or like areas or environments.

In embodiments, the disclosure provides an apparatus comprising:
an illumination source; and
a climate controlled enclosure having at least one light diffusion element situated within the enclosure, the at least one light diffusion element being in photonic communication with the illumination source, and the illumination source being remote to the enclosure, i.e., at least situated outside of the climate controlled area or environmentally controlled (e.g., temperature, humidity, pressure, or a combination thereof) area of the enclosure. “Photonic communication” as used herein refers to a functional linkage between the external illumination source and the internally situated light diffusion element(s) sufficient to provide for the transmission of photons from the source into the light diffusion element so that light is transported through the light diffusion element and emitted therefrom. This could occur, for example, via a direct coupling or linkage between the illumination source and the light diffusion element; an indirect coupling or linkage between the illumination source and the light diffusion element such as by having an intervening optical fiber between the illumination source and light diffusion element; a free space coupling or linkage between the illumination source and the light diffusion element such as an unobstructed line-of-sight space or conduit between a laser or other light source (e.g., an LED) directed to the light diffusion element, or other suitable device or instrumentality that permits efficient photon transmission between the source and light diffusion element such that the light diffusion element emits light.

In embodiments, the apparatus can further comprise, for example, a climate controller, such as a temperature controller, pressure controller, humidity controller, or a combination thereof, and any associated sensing and signaling structure, in communication with the interior of the enclosure. The controller can regulate the interior to a temperature, pressure, or humidity other than the ambient temperature, pressure, or humidity, using for example, a heater or a chiller for regulating or maintaining a desired temperature, a humidifier or a dehumidifier for regulating or maintaining a desired humidity, a pump such as a vacuum pump or pressurizing pump for regulating or maintaining a desired pressure, or a combination thereof, and like temperature, pressure, or humidity control or regulating devices.

In embodiments, the temperature, humidity, or pressure, other than the ambient, is below or above the ambient temperature, is below or above ambient humidity, is below or above the ambient pressure, or a combination thereof by, for example, from about 1 to 99 relative percent. The ambient temperature can be, for example, any temperature in the operable range of the light source, the enclosure, the contents or work pieces within the enclosure, and associated componentry, such as from −50° F. to about 400° F. and like temperatures, including intermediate values and ranges. The ambient humidity can be, for example, any humidity within the operable range of the light source, the enclosure, the contents or work pieces within the enclosure, and associated componentry, such as from 1 to 99 relative percent, including intermediate values and ranges. The ambient pressure can be, for example, any pressure within the operable range of the light source, the enclosure, the contents or work pieces within the enclosure, and associated componentry, such as from 1 to 99 relative percent difference from standard pressure or other ambient pressure, including intermediate values and ranges, such as 101.325 kPa (“kiloPascals”), 1013.25 millibars or hectopascals, 760 mmHg (torr), 29.92 in Hg, 14.696 psi, and like units of measure or equivalents.

In embodiments, the enclosure can be a functional space selected from, for example, at least one of a refrigerator, a freezer, a cooler, a display case, a storage area, a food processing area, a materials processing area, a materials extraction area, e.g., a mine shaft, a packing area, an oven, a warming area, a microwaving area, an annealing area, a high humidity area, e.g., a sauna, a natatorium, a botanical garden or greenhouse, having a relative humidity (RH), for example, of from about 25 to about 99%, a humidity controlled area, e.g., a humidor area, a wine room or wine cellar, e.g., at an RH of about 60%, an aging area, and like areas having a relative humidity controlled to a target humidity within or having an operating RH difference of about 1 to 10%, a high condensation area having, for example, moisture present or a propensity of a gaseous phase to become a liquid or solid phase, such as having a dew point within about 5 to about 10° F. of the temperature within the enclosure, for example, a steam room or steam bath, and like high humidity or high condensation areas.

In embodiments, the illumination source can be, for example, an LED, a laser, a metal halide light, and like sources, or a combination thereof

In embodiments, the illumination source can have, for example, a high coupling efficiency such as of from about 40 to about 95% and high communication efficiency such as of from about 50 to about 99% between the illumination source and light diffusing element.

In embodiments, the apparatus can further include, for example, a light transmission element situated between the illumination source and the light diffusion element, the light transmission element having a high coupling efficiency such as of from about 40 to about 95% between the illumination source and transmission element, or between the transmission element and the light diffusion element. In embodiments, the at least one light diffusion element can be, for example, at least one fiber having a glass core.

In embodiments, the apparatus can further include, for example, a material on or associated with at least a portion of the surface of the light diffusion element, e.g., such as a mask, a coating, a cladding, and like light blocking, light shielding, or reflective materials.

In embodiments, the light diffusion element can be, for example, at least one fiber having a core and the material on at least a portion of the outer surface of the light diffusion element can be, for example, a cladding material, a phosphor, a pigment, a polymer, and like materials, or a combination thereof.

In embodiments, the material on or associated with at least a portion of the surface of the light diffusion element can have, for example, from about 10 to about 95% radial surface coverage, from about 20 to about 80% radial surface coverage, from about 30 to about 50% radial surface coverage, and like radial surface coverage values, including intermediate values and ranges.

In embodiments, the at least one light diffusion element can be, for example, a fiber, a bundle of fibers, that is, a plurality of fibers bundled together, a fiber preform, that is, a light diffusing rod, and like elements, or a combination thereof.

In embodiments, the light from the illumination source can be, for example, visible light, non-visible light, or a combination thereof The non-visible light from the light source can include, for example, infrared light, ultraviolet light, and like light or radiation, or combinations thereof.

In embodiments, the at least one light diffusion element (LDF) can be, for example, at least one of
a single stranded LDF;
a single stranded LDF having an illumination source in communication with each end of the strand;
a double stranded LDF having a single illumination source;
a multiply stranded LDF having a single illumination source;
a single stranded LDF having at least one closed loop from a single illumination source;
or a combination thereof.

In embodiments, the disclosure provides a method of illuminating the interior space of the climate controlled enclosure of the above mentioned apparatus, the method including, for example:
transmitting light from the illumination source to at least one light diffusion element situated within the enclosure to illuminate the interior space of the enclosure.

Numerous patents and publication mention an apparatus having, for example, a light source and an optical fiber in photonic communication with the light source. However, these apparatuses provide light from the source to a specific end point target, i.e., end point illumination, and not general or directed light diffusion illumination within a climate controlled enclosure as in the present disclosure.

U.S. Pat. No. 6,418,252, entitled “Light Diffusing Fiber Optic Chamber,” to Maitland, mentions a light diffusion system for transmitting light to a target area. The light is transmitted in a direction from a proximal end to a distal end by an optical fiber. A diffusing chamber is operatively connected to the optical fiber for transmitting the light from the proximal end to the distal end of the fiber, and transmitting the light to the target area. A plug is operatively connected to the diffusing chamber for increasing the light that is transmitted to the target area. The light can be used for heating or otherwise (unspecified) treating a target.

In embodiments, the present disclosure can provide an apparatus having a single light diffusing fiber or LDF bundle. In embodiments, the apparatus provides a method of use for delivering photons from an illumination source or light source to a climate controlled enclosure, such as the cooled portion of the enclosure, for example, a refrigeration unit, a cooler, or a cooled processing structure.

The photon source or illumination source that provides light for illumination can be, for example, a laser diode or an LED that is further coupled into a light diffusing element, which diffusing element can be, for example, a fiber or a fiber bundle.

Other light sources in the non-visible (such as UV or IR) region of the electromagnetic spectrum can be coupled to, separately or in combination with, the LDF fiber or the fiber bundle to allow the delivered light such as UV light to, for example, decontaminate or sterilize the temperature controlled area or portions thereof IR light can be used, for example, in advertising, in signaling, in communications, or like applications.

The alternative or additional wavelength source(s) can be co-deployed with a fiber attached to the LED or a laser as described herein. The two or more wavelength source(s) can be joined to a single fiber by, for example, use of combiner light circuitry, or like combination of the light sources.

In embodiments, the light source can be coupled into a transmission fiber and then remotely delivered by the LDF element if the application calls for it. The light subsequently diffuses out of the surface of the LDF element and illuminates the interior of the enclosure. The connection point, which may be somewhat lossy (energy dissipating), depending on type of diffusing design (single fiber, fiber bundle, fiber preform, rod, etc.) can be situated within the climate controlled enclosure. Two connections may be called for by the system, for example, having one connection between the light source and the delivery part, and another connection between the delivery part and the light diffusing component or fixture. In a LDF bundle the coupling between an LED source and an LDF can be, for example, other than 100% efficient. Efficient coupling between the LED and a delivery part is preferred. The delivery part can be, for example, a monofilament plastic optical fiber (POF), glass cane, or like structure or configurations, which can have a very high numerical aperture (NA), for example, of about 0.9 to about 1.0, and provides efficient coupling, and has less efficient coupling inside of the cooled space, so that the disclosed externally situated light source apparatus and methods can be used for illumination.

The flexible nature of the LDF element permits positioning of the LDF element so that the emitted or diffused light can enhance the look or appearance of the product or contents (e.g., beverages, etc.) inside or within the enclosure. Numerous alternative bundling and source architectures can be employed to attain desired lumen levels or light distribution targets. Depending on the design, if straight sections of the fixture are to be illuminated, a large size core LDF or diffusing preform can, for example, be used. The diameter of the light diffusing preform or rod can be, for example, from about 1 to about 5 mm The design of a preform is described in the aforementioned commonly owned and assigned U.S. patent application Ser. No. 13/800184.

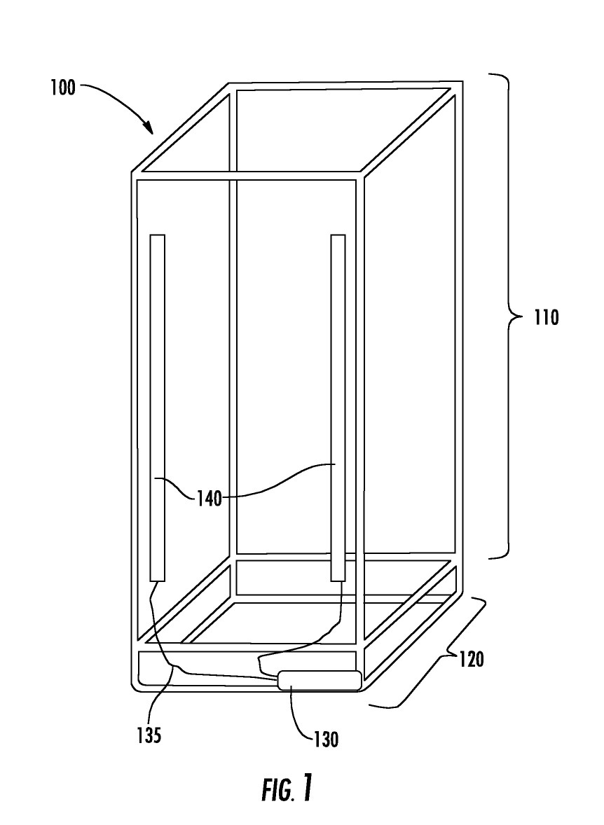

Referring to the Figures, FIG. 1 shows an example deployment scheme for a light diffusing fiber (LDF) within an apparatus or structure (100) having a climate controlled or environmentally controlled enclosure (110) such as a standing beverage cooler having, for example, a hinged door (not shown) or like closure means, including: the climate controlled enclosure (110) such as, a cooled space; a space (120) at ambient temperature; a light or illumination source (130) external to the enclosure (110); optionally a light transmission element (135); and a light distribution element (140), which distribution element is preferably thermally passive, e.g., not highly thermally conductive and situated substantially or entirely inside the enclosure (110).

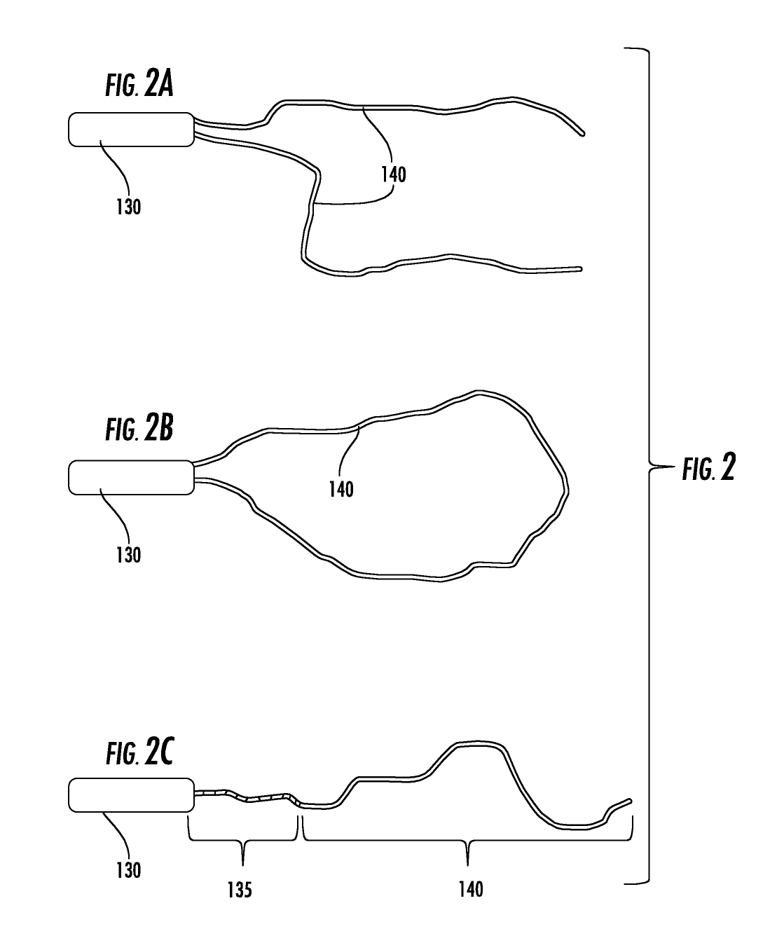

FIGS. 2A to 2C show several exemplary delivery or distribution architectures for LDF illumination. FIG. 2A shows a double stranded LDF (140) configuration from the light source (130). FIG. 2B shows a single stranded LDF (140) loop configuration from the light source (130). An advantage of the architectures shown in FIGS. 2A and 2B is that one light engine having a larger surface area can drive multiple fibers, or alternatively or additionally, can drive both ends of one fiber to provide improved uniformity. FIG. 2C shows a single stranded LDF (140) configuration from the light source (130) further including an intermediate light transmission element (135) between the source (130) and the LDF (140).

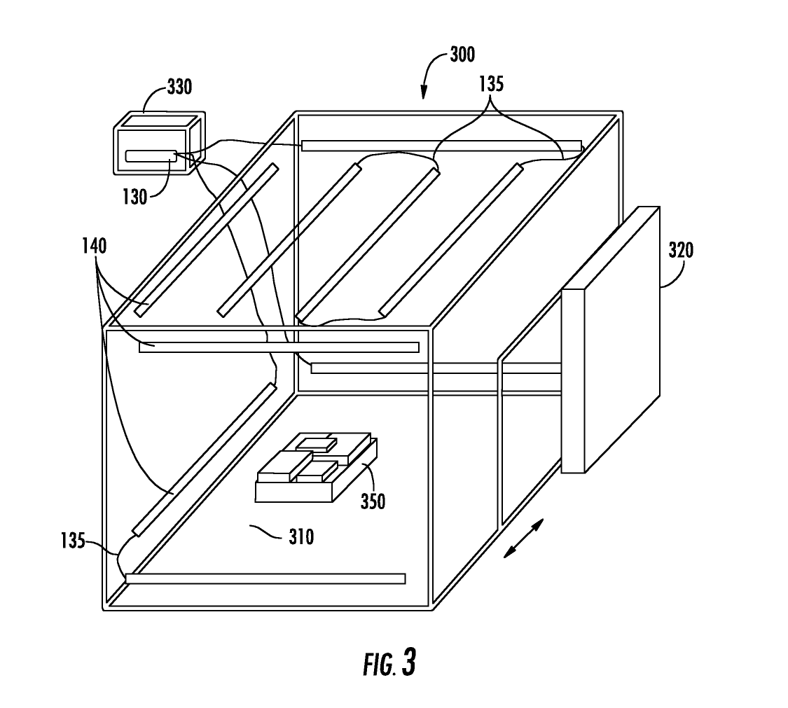

FIG. 3 shows an exemplary deployment scheme for the disclosed apparatus and method using LDF equipment and methods within an industrial or large scale setting, such as for food handling, a warehouse having very large coolers, or a frozen food packing area. The warehouse cooler enclosure (300) encompasses all or a portion of the cooled interior space (310) optionally having a door (320) or like other suitable opening and closure means. The external remote enclosure (330) or space is at, for example, ambient temperature and can be used to house the illumination source (130), and is purposely situated outside the climate or temperature regulated enclosure, i.e., the cooled space. The light or illumination source (130) is also at ambient temperature and is outside the cooled interior space (310). The light distribution element(s) (140) are preferably passive and are preferably inside the enclosure (300) area to illuminate the goods, products, or work pieces (350) situated within the enclosure (300). In embodiments, the LDF element(s) (140) can be linked in a series with one or more intervening transmission elements (135).

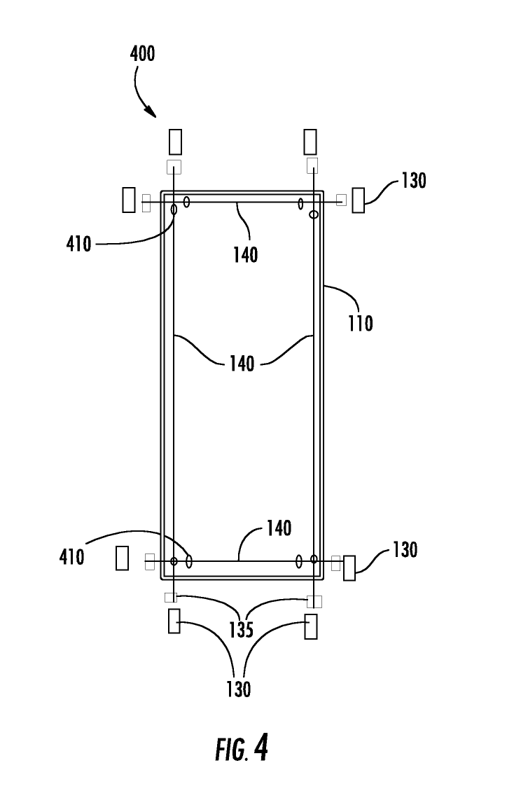

FIG. 4 shows in plan view another exemplary deployment scheme and apparatus (400) for a light diffusing fiber (LDF) element (140) within a climate controlled environment (110), such as a cooled space bounded by containment walls, including: a light or illumination source (130) at ambient temperature and external to the enclosure (110); one or more light transmission elements (135), which transmission elements are high efficiency and situated substantially or entirely outside of the enclosure (110). The efficiency of coupling at location (410) can be, for example, from about 40 to about 90%, which means that from about 10 to about 60% of the source light is dissipated or compromised at this point. The redirection of this dissipated or compromised light for interior illumination ensures that the efficiency of the lighting system is unaffected or the negative impact is minimized

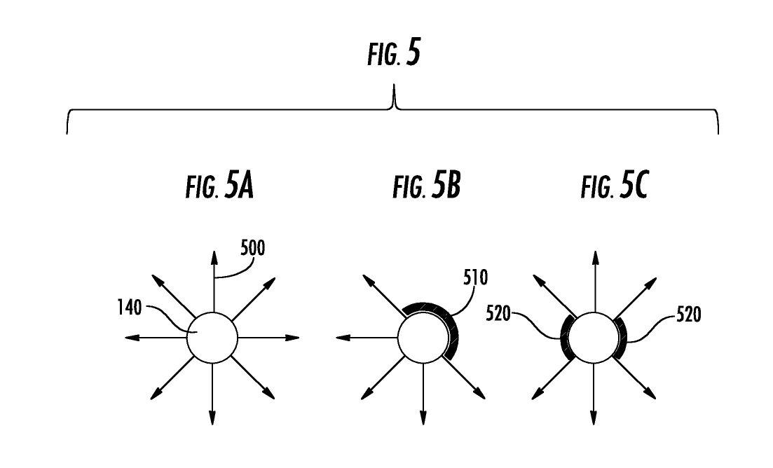

FIGS. 5A to 5C show in cross-section exemplary unmodified, and modified or coated LDF fibers and their accompanying illumination patterns and as discussed further below.

The figures are not necessarily to scale. Like reference numerals used in the figures refer to like components. However, it will be understood that the use of a numeral to refer to a component in a given figure is not intended to limit the component in another figure labeled with the same numeral.

The apparatus can use, for example, a light diffusing fiber having a glass core, optionally coated with, for example, one or more phosphors or pigments, to illuminate the interior space and improve illumination efficiency. Efficiency gains can be realized by, for example, entirely eliminating or significantly reducing the number of photon sources, light sources, or light engines (e.g., fewer lights) placed internally (i.e., within or inside) or externally and in contact with a cooled portion of the enclosure unit.

The disclosure provides advantages over known space illumination apparatus and methods. The present disclosure provides an apparatus and methods that are advantaged by, for example, the placement of the light source(s) outside or external to the climate controlled space or environmentally controlled space, such as a cooled space or cooled area of a unit. The external location of the illumination source relative to the controlled space reduces the comparative or net energy consumption of the apparatus because excess energy used to maintain the internal cool temperature using conventional illumination sources for lighting and color generation can be eliminated.

Having the light source or photon generating element situated outside the cooled space can reduce the energy consumed by the competing energy demands of, for example, maintaining the light source temperature with heating at or above the ambient temperature while simultaneously maintaining a sub-ambient temperature of the enclosure with cooling.

The external light source selected for use in the present apparatus and method can have a longer lifetime compared to same or similar light source situated within the controlled space, when the source is used continuously or when the door to the controlled space is repeatedly opened, for example, because the switching cycle (ON/OFF) of the external light source in a stable room temperature environment is typically OFF longer or ON less frequently.

Moisture condensation or the potential for frost or ice build on the light source and associated circuitry is significantly minimized or eliminated when the light source and circuitry are situated remote to or outside the enclosure's climate controlled space.

The flexibility of the light diffusing fiber (LDF) (e.g., alone or in bundles) permits designs and illumination schemes in apparatus and methods operating at reduced temperatures, such as below ambient room temperatures.

In embodiments, the light source can be connected to one or more transmission fibers or bundles to maintain the light intensity until the light reaches the desired delivery area or illumination target.

In embodiments, the LDF can be coupled to a variety of photon sources or light sources including, for example, LED's or lasers for remote illumination, or to other, or in combination with specialized light sources such as UV for sterilization cycles or IR for communication through an IR signal to mobile or remote devices such as sensing and signaling embodiments, and applications thereof.

In embodiments, use of various optional jacket materials on the LDF can provide, for example, protection in harsh environments, satisfaction of regulatory compliance, or to increase handling properties of the LDF, such as low temperature ductility or flexibility.

An LDF having jacket material and having a reflective material on the jacket itself, or having a reflective material in close proximity to the LDF, can provide an optimal illumination pattern in angular space. “Angular space” is the uniform distribution of light at different viewing angles relative to the direction of light propagation in an illumination element or source.

Referring again to FIGS. 5A to 5C, FIG. 5A shows in cross-section that an unmodified LDF fiber (140) scatters light (500) radially in a 360 degree illumination pattern, which illumination directionality follows the fiber's exterior geometry in cross-section. In embodiments, the at least one light diffusion element can emit light from only a portion of the side region of the diffusion element FIG. 5B shows a modified LDF fiber (140), such as having a reflector (510), coating, partial cladding, and like modifications, on a portion of the fiber's circumference. Here light does not come out where the reflector or the coating is present, i.e., the reflector limits the angular output. The percentage of the circumference of the fiber that is reflectively coated can control the area illuminated, for example, a half coating coverage is 180 degrees and provides 180 degrees illumination, a three-quarters coverage is 270 degrees and provides 90 degrees illumination, and like coating coverages and the corresponding illumination areas, including intermediate values and ranges. FIG. 5C shows another modified LDF fiber (140), such as having a coating (520) on opposite sides (i.e., double coated) to block illumination of the associated opposing blocked areas and to illuminate opposing unblocked areas of the intervening uncoated fiber at the same time, for example, above and below, or left-side and right-side, depending on the specifics of the relative orientation of the LDF, and the coating pattern and coating coverage on the LDF.

The LDF offers users high flexibility of placement of individual lighting elements that can enhance overall product display and placement, including, for example, directed illumination of racks, overall space illumination, directed target locations or specific products, illumination of containers from below, side, above, or combination thereof

Within a large freezer environment additional advantages can include, for example, improved worker safety, ability to create a solar spectrum (e.g., to assist with working indoors), low physical profile, energy savings, and taller or wider than standard cooler geometries because of the reduced freezer temperatures and reduced, i.e., unnecessary, cooling capacity.

In embodiments, the uniformity aspect of the light defusing fiber (LDF) element, and the absence of an array of point sources common to LED's, can provide an aesthetic illumination advantage to, for example, the climate controlled cooled space within the enclosure.

In embodiments, the LDF can be used to deliver light directly into the enclosure such as the cooled space of a device, or alternatively, the LDF can be coupled to a flat or non-flat glass plate, such as those on a cooler/freezer door, and used, for example, to illuminate such as back lighting a design (permanent or temporary) on the surface of the glass plate.

In embodiments, potential energy savings of from about 10 to 80%, from about 10 to 60%, from 12 to 40%, from about 15 to 20%, and like savings, including intermediate values and ranges, can be realized by such an externally lighted system, for example, when the light source is an LED situated outside of the climate controlled space and having an LDF situated inside the climate controlled space, compared to the same LED light source situated inside the cooled space and without an LDF situated inside the cooled space. In embodiments, potential energy savings, such as about 60%, can be realized by such an externally lighted system, such as when the light source is an LED and is situated outside of the cooled space, compared to, for example, use of a fluorescent light source, as listed in Table 1.

Additional operating schemes including one or more LDF components, such as listed in Table 1, can be included in embodiments of the present disclosure.

To achieve the disclosed energy saving advantages on installed systems, a retrofit device or kit can be used for a variety of climate controlled cooler or refrigerator designs such that retail outlets can realize benefits and advantages immediately and without a significant capital outlay.

The ability to transport light to an active light diffusing fiber within the climate controlled, e.g., acooled enclosure allows, for example, a single or central light source, such as a laser station or LED station, that can supply one or more, such as a plurality or bank of climate controlled enclosures, with a fiber connection being made at each enclosure. This single illumination source can further reduce energy consumption, simplify service, and eliminate the need for a new light source when climate controlled enclosure changes are called-for for other reasons, such as physical damage, wear and tear, obsolescence of the current enclosure, and like changes.

The fiber layout within the climate controlled cooler can be created and reconfigured if desired such that the layout pattern can be further adjusted by the end user, such as a merchant or operator for different products, providing a greater degree of illumination design freedom and apparatus versatility, such as providing multiple uses or purposes.

The disclosed implementations and other implementations are within the scope of the following claims. One skilled in the art will appreciate that the present disclosure can be practiced in embodiments other than those disclosed. The disclosed embodiments are presented for purposes of illustration and not limitation.

TABLE 1
Energy consumption and cost comparisons for the inventive apparatus and
method versus alternate light sources or schemes.

| | Light Source | | | | | |
|---|---|---|---|---|---|---|
| Metric | Inc¹ | T12² | T8³ | LED⁴ | Laser/Fiber⁵ | LED/LDF⁶ |
| Lumens | 1000 | 1000 | 1000 | 1000 | 1000 | 1000 |
| Watts | 70 | 22 | 20 | 14 | 21 | 19 |
| Watts + due to Source | 87 | 28 | 25 | 15 | 21 | 19 |
| Cooling | | | | | | |
| Lumens/Watt | 11 | 36 | 40 | 65 | 49 | 53 |
| Ballast (Fluor) | | 3.3 | 3.0 | | | |
| Heat Load (W) | 85 | 24 | 22 | 10 | 15 | 12 |
| Watts to Remove | 85 | 24 | 22 | 10 | 0 | 0 |
| Total energy (W) for | 155 | 50 | 45 | 24 | 21 | 19 |
| cooled space | | | | | | |
| Life (hrs) | 1000 | 5000 | 5000 | 50000 | 50000 | 50000 |
| Life (yrs) | 0.1 | 0.6 | 0.6 | 5.7 | 5.7 | 5.7 |
| Initial Price | $0.25 | $60.00 | $62.00 | $320 | | |
| Replacement | $0.25 | $16.00 | $18.00 | — | — | — |
| cost/freezer/time | | | | | | |
| Replacement cost/freezer | $12.50 | $160.00 | $180.00 | — | — | — |
| for 50 k hrs | | | | | | |
| Energy cost/yr @80% | $109 | $35 | $32 | $17 | $14 | $13 |
| 5.7 yr energy cost @80% | $620 | $198 | $180 | $96 | $82 | $76 |
| Total cost for 5.7 yrs | $633 | $418 | $422 | $416 | $82 | $76 |
| LDF System Price Estimate | | | | | $334 | $340 |

¹Inc = incandescent source
²T12 = fluorescent tube illuminant source
³T8 = fluorescent tube illuminant source
⁴LED = light emitting diode source
⁵Laser/Fiber = inventive laser light source and fiber coupled distribution
⁶LED/LDF = inventive light emitting diode (LED) source and light diffusing fiber coupled distribution

What is claimed is:

1. An apparatus comprising:
an illumination source; and
a climate controlled enclosure having at least one light diffusion element situated within the enclosure, the at least one light diffusion element being in photonic communication with the illumination source, and the illumination source being remote to the enclosure.

2. The apparatus of claim 1 further comprising a climate controller in communication with the interior of the enclosure, the controller regulates the interior of the enclosure to: a temperature other than the ambient temperature; an humidity other than the ambient humidity; a pressure other than the ambient pressure; or a combination thereof.

3. The apparatus of claim 2 wherein the temperature, humidity, or pressure, other than the ambient, is below or above the ambient temperature, is below or above ambient humidity, is below or above the ambient pressure, or a combination thereof by from about 1 to 99 relative percent.

4. The apparatus of claim 1 wherein the enclosure comprises a space selected from at least one of a refrigerator, a freezer, a cooler, a display case, a storage area, a food processing area, a materials processing area, a materials extraction area, a packing area, an oven, a warming area, a microwaving area, a high humidity area, a humidity controlled area, a high condensation area, or a combination thereof

5. The apparatus of claim 1 wherein the illumination source comprises an LED, a laser, a metal halide light, or a combination thereof

6. The apparatus of claim 1 further comprising a light transmission element situated between the illumination source and the light diffusion element having high coupling efficiency of from about 40 to about 95% between the illumination source and transmission element.

7. The apparatus of claim 1 wherein the at least one light diffusion element comprises at least one fiber having a glass core.

8. The apparatus of claim 1 further comprising a material on at least a portion of the surface of the light diffusion element.

9. The apparatus of claim 1 wherein the light diffusion element is at least one fiber having a core and having material on at least a portion of the outer surface of the light diffusion element.

10. The apparatus of claim 9 wherein the material on at least a portion of the surface of the light diffusion element comprises a phosphor, a pigment, a polymer, or a combination thereof

11. The apparatus of claim 9 wherein the material on at least a portion of the surface of the light diffusion element comprises from about 10 to about 95% radial surface coverage.

12. The apparatus of claim 1 wherein the illumination source has high coupling efficiency of from about 40 to about 95% and high communication efficiency of from about 50 to about 99% between the illumination source and light diffusing element.

13. The apparatus of claim 1 wherein the at least one light diffusion element comprises a fiber, a bundle of fibers, a fiber preform, or a combination thereof

14. The apparatus of claim 1 wherein the light from the illumination source comprises visible light, non-visible light, or a combination thereof

15. The apparatus of claim 1 wherein the at least one light diffusion element (LDF) comprises at least one of:
a single stranded LDF;
a single stranded LDF having an illumination source in communication with each end of the strand;
a double stranded LDF having a single illumination source;
a multiply stranded LDF having a single illumination source;
a single stranded LDF having at least one closed loop from a single illumination source;
or combinations thereof.

16. The article of claim 1 wherein the at least one light diffusion element emits light from only a portion of a side region of the diffusion element.

17. A method of illuminating the interior space of the climate controlled enclosure of the apparatus of claim 1, comprising:
transmitting light from the illumination source to at least one light diffusion element situated within the enclosure to illuminate the interior space of the enclosure.

18. The method of claim 17 further comprising controlling the climate of the interior space before, during, after, or combinations thereof, the transmitting of light from the illumination source.

19. The method of claim 17 further comprising a light transmission element situated between the illumination source and the diffusion element, the light transmission element having a high coupling efficiency of from about 40 to about 95% between the illumination source and the diffusion element.
